(19) United States
(12) Patent Application Publication
(10) Pub. No.: US 2015/0372429 A1
(43) Pub. Date: Dec. 24, 2015

(54) PLUG CONNECTOR, ELECTRONIC APPARATUS INCLUDING RECEPTACLE AND CONNECTING METHOD OF ELECTRONIC APPARATUS

(71) Applicant: SAMSUNG ELECTRONICS CO., LTD., Suwon-si (KR)

(72) Inventors: Jin LEE, Suwon-si (KR); Kyeong-jae LEE, Seoul (KR)

(73) Assignee: SAMSUNG ELECTRONICS CO., LTD., Suwon-si (KR)

(21) Appl. No.: 14/749,029

(22) Filed: Jun. 24, 2015

(30) Foreign Application Priority Data
Jun. 24, 2014 (KR) 10-2014-0077484
Apr. 15, 2015 (KR) 10-2015-0052974

(51) Int. Cl. H01R 13/66

(52) U.S. Cl. CPC H01R 13/665

(57) ABSTRACT

An electronic apparatus, including: a receptacle including: a plurality of pin groups electrically connectable to the plug connector including a plurality of plug terminals disposed on respective surfaces of the plug connector; a first pin group of the plurality of pin groups disposed on a first surface including a first pin; and a second pin group of the plurality of pin groups disposed on a second surface including a second pin; and a processor configured to detect a voltage value of the first pin, to detect a voltage value of the second pin, and to determine a connecting direction of the plug connector based on the detected voltage value of the first pin and the detected voltage value of the second pin

### CROSS-REFERENCE TO RELATED APPLICATIONS

This application claims priority from Korean Patent Application No. 10-2014-0077484, filed on Jun. 24, 2014, in the Korean Intellectual Property Office, and Korean Patent Application No. 10-2015-0052974, filed on Apr. 15, 2015 in the Korean Intellectual Property Office, the disclosures of which are incorporated herein by reference in their entireties.

### BACKGROUND

1. Field

Apparatuses and methods consistent with one or more aspects of one or more exemplary embodiments relate to a plug connector, an electronic apparatus including a receptacle, and a connecting method of the electronic apparatus, and more particularly, to a plug connector connected to a receptacle included in an electronic apparatus, an electronic apparatus including the receptacle, and a connecting method of the electronic apparatus.

2. Description of the Related Art

With the development of electronic technologies, various types of electronic products have been developed and propagated. Recently, manufacturing companies, communication companies, etc., have focused on how to more conveniently provide services and interfaces to users. Therefore, products having new functions have emerged.

A cable may be used to connect various apparatuses and to transmit a signal between the apparatuses. A distal end of the cable is provided with a plug connector, and, thus, the cable is configured to be connected to receptacles of the apparatuses.

Typically, when the receptacle of the electronic apparatus is connected to the plug connector, one surface of the plug connector needs to accurately match one surface of the receptacle to connect between the receptacle and the plug connector. A user must consider connecting directions of both of the plug connectors when connecting the plug connectors to the receptacles, and therefore experiences inconvenience.

To address the above problems in the related art, manufacturing companies, etc., use a method of printing a user identification mark of the plug connector on an appearance of the plug connector, etc., to improve the user convenience. However, a failure may occur at the connecting portion between the receptacles or the plug connectors due to the user using devices at night, user's carelessness, etc.

### SUMMARY

Exemplary embodiments overcome the above disadvantages and other disadvantages not described above. However, an exemplary embodiment is not required to overcome all of the disadvantages described above, and an exemplary embodiment may not overcome any of the disadvantages described above.

According to an aspect of one or more exemplary embodiments, there is provided a plug connector which may be connected to an electronic apparatus without a user paying special attention, an electronic apparatus including a receptacle, and a connecting method of the electronic apparatus.

According to an aspect of one or more exemplary embodiments, there is provided a method of determining a connection between an electronic apparatus and a plug connector without performing handshaking between the electronic apparatus and the plug connector including a cable.

According to an aspect of one or more exemplary embodiments, there is provided an electronic apparatus including: a receptacle including: a plurality of pin groups electrically connectable to the plug connector including a plurality of plug terminals disposed on respective surfaces of the plug connector; a first pin group of the plurality of pin groups disposed on a first surface including a first pin; and a second pin group of the plurality of pin groups disposed on a second surface including a second pin; and a processor configured to detect a voltage value of the first pin, to detect a voltage value of the second pin, and to determine a connecting direction of the plug connector based on the detected voltage value of the first pin and the detected voltage value of the second pin.

The processor is further configured to determine the connecting direction of the plug connector based on whether at least one plug terminal disposed on a first surface of the plug connector is connected to the first pin group or the second pin group, when the plug connector is received in the receptacle.

The first pin of the first pin group and the second pin of the second pin group may be 180° symmetrical to each other, and the processor may be further configured to determine the connecting direction of the plug connector based on whether the at least one plug terminal disposed on the first surface of the plug connector is connected to the first pin or the second pin.

The receptacle may further include: a first pull up resistor connected to the first pin; and a second pull up resistor connected to the second pin, and the processor may be further configured to detect the voltage values of the first pin and the second pin based on the first pull up resistor and the second pull up resistor.

The at least one plug terminal may be disposed on the first surface of the plug connector is connected to a ground terminal.

The first pin and the second pin of the receptacle may be configured to be used for at least one of cable detection and cable identification.

The receptacle may be a receptacle for a mobile high-definition link (MHL).

The first pin group may include a first pair of end pins configured to supply power, the second pin group may include a second pair of end pins configured to supply power, and each of the first pin group and the second pin group may include at least one of a pin for data signal transmission, a pin for control signal transmission, a ground pin, and a pin for cable detection.

The pin for cable detection may be configured to be operated as a pin for receiving information of the plug connector.

The receptacle may include: a first pull up resistor connected to the first pin; and a second pull up resistor connected to the second pin. The processor may be further configured to detect the voltage value of the first pin and the voltage value of the second pin based on a pull down resistor included in an external apparatus connected through the plug connector, when the plug connector is received in the receptacle.

The processor may be further configured to: determine, in response to the voltage value of the first pin being detected to be larger than a preset voltage value and the voltage value of the second pin being detected to be smaller than the preset voltage value, that the plug connector is connected to the receptacle in a first connecting direction, and determine, in response to the voltage value of the first pin being detected to be smaller than the preset voltage value and the voltage value of the second pin being detected to be larger than the preset voltage value, that the plug connector is connected to the receptacle in a second connecting direction.

According to another aspect of one or more exemplary embodiments, there is provided a receptacle connected to a plug connector including: a first pin group disposed on one surface; and a second pin group disposed on the other surface, wherein the first pin group includes a first pin to which a first pull up resistor is connected and the second pin group includes a second pin having a second pull up resistor connected thereto and disposed 180° symmetrical to the first pin.

The first pin and the second pin of the receptacle may be used as at least one of a usage for cable detection and a usage for cable identification.

According to another aspect of one or more exemplary embodiments, there is provided a plug connector connected to a receptacle, the plug connector including: a first terminal group disposed on a first surface; and second terminal group disposed on a second surface, wherein the first terminal group may include a first terminal connected to a ground terminal.

The first terminal may be connected to the ground terminal through a pull down resistor.

The plug connector may further include a chip for identification of the plug connector.

The second terminal group may include a second terminal disposed 180° symmetrical to the first terminal and connected to the chip.

The chip may include information of the plug connector, and the information of the plug connector may include at least one of standard information and original product information of the plug connector.

The plug connector may further include a third terminal group disposed on a third surface, and the first terminal group, the second terminal group, and the third terminal group may be disposed rotationally symmetrical relative to each other.

According to another aspect of one or more exemplary embodiments, there is provided a connecting method of an electronic apparatus including a plurality of pin groups electrically connected to a plug connector, the connecting method including: detecting a voltage value of a first pin of a first pin group of the plurality of pin groups disposed on a first surface; detecting a voltage value of a second pin of a second pin group of the plurality of pin groups disposed on a second surface; and determining a connecting direction of the plug connector based on the detected voltage values of the first pin and the second pin.

The determining may include: determining, in response to the voltage value of the first pin being detected to be larger than a preset voltage value and the voltage value of the second pin being detected to be smaller than the preset voltage value, that the plug connector is connected to a receptacle in a first connecting direction; and determining, in response to the voltage value of the first pin being detected to be smaller than the preset voltage value and the voltage value of the second pin being detected to be larger than the preset voltage value, that the plug connector is connected to the receptacle in a second connecting direction opposite to the first connecting direction.

The determining may further include determining, in response to both of the voltage value of the first pin and the voltage value of the second pin being detected to be larger than the preset voltage value, that the plug connector is not connected to the electronic apparatus.

The second pin may be rotationally symmetrical to the first pin.

According to another aspect of one or more exemplary embodiments, there is provided a receptacle configured to be connected to a plug connector, the receptacle including: a first pin group disposed on a first surface; and a second pin group disposed on a second surface, wherein the first pin group includes a first pin connected to a first pull up resistor, wherein the second pin group includes a second pin connected to a second pull up resistor, and wherein the second pin is disposed 180° symmetrical to the first pin.

The first pin and the second pin of the receptacle may be configured to be used for at least one of cable detection and cable identification.

According to another aspect of one or more exemplary embodiments, there is provided a receptacle configured to be connected to a plug connector, the receptacle including: a first pin hole group disposed on a first surface of the receptacle; a first pin hole in the first pin hole group; a first pull up resistor connected to the first pin hole; a second pin hole group disposed on a second surface of the receptacle; a second pin hole in the second pin hole group; and a second pull up resistor connected to the second pin hole, wherein the second pin hole is disposed symmetrical to the first pin hole.

The receptacle may further include: a third pin hole group disposed on a third surface of the receptacle; a third pin hole in the third pin hole group; and a third pull up resistor connected to the third pin hole, wherein the third pin hole is disposed with rotational symmetry relative to the first pin hole and the second pin hole.

According to another aspect of one or more exemplary embodiments, there is provided an electronic apparatus including: a receptacle configured to connect to a plug connector, the receptacle including: a first pin hole group disposed on a first surface of the receptacle; a first pin hole in the first pin hole group; a first pull up resistor connected to the first pin hole; a second pin hole group disposed on a second surface of the receptacle; a second pin hole in the second pin hole group; and a second pull up resistor connected to the second pin hole, and a processor configured to: detect a voltage value of the first pin hole; detect a voltage value of the second pin hole; and determine a connection orientation of the plug connector based on the detected voltage value of the first pin hole and the detected voltage value of the second pin hole.

The processor may be further configured to determine, in response to a voltage value of the first pin hole and the voltage value of the second pin hole both being detected to be greater than a threshold, that the plug connector is not connected to the receptacle.

The receptacle may further include: a third pin hole group disposed on a third surface of the receptacle; a third pin hole in the third pin hole group; and a third pull up resistor connected to the third pin hole, the first pin hole, the second pin hole, and the third pin hole may be disposed with rotational symmetry relative to each other, and the processor may be further configured to: detect a voltage value of the third pin hole; and determine a connection orientation of the plug connector based on the detected voltage value of the first pin hole, the detected voltage value of the second pin hole, and the detected voltage value of the third pin hole.

Additional and/or other aspects and advantages of one or more exemplary embodiments will be set forth in part in the description which follows and, in part, will be obvious from the description, or may be learned by practice of one or more exemplary embodiments.

### BRIEF DESCRIPTION OF THE DRAWING FIGURES

The above and/or other aspects of one or more exemplary embodiments will be more apparent by describing certain exemplary embodiments with reference to the accompanying drawings, in which:

FIG. 1 is a diagram illustrating an electronic apparatus including a receptacle connected to a plug connector according to an exemplary embodiment;

FIG. 2 is a block diagram illustrating a configuration of the electronic apparatus according to an exemplary embodiment;

FIG. 3A is a cross-sectional view of the plug connector according to an exemplary embodiment;

FIGS. 3B to 3D are diagrams illustrating a configuration of the plug connector and the receptacle according to an exemplary embodiment;

FIG. 4A is a diagram illustrating a circuit configuration of the plug connector according to an exemplary embodiment;

FIG. 4B is a diagram illustrating a pin disposition of a plug connector 300 according to an exemplary embodiment;

FIG. 5A is a diagram illustrating a circuit configuration of a receptacle according to an exemplary embodiment;

FIG. 5B is a diagram illustrating a pin hole disposition of a receptacle 110 according to an exemplary embodiment;

FIG. 6 is a diagram illustrating the plug connector and the receptacle which are connected in a first direction, according to an exemplary embodiment;

FIG. 7 is a diagram illustrating the plug connector and the receptacle which are connected in a second direction, according to an exemplary embodiment;

FIG. 8 is a flowchart illustrating a method of connecting the plug connector and the receptacle according to an exemplary embodiment; and

FIGS. 9 and 10 are diagrams for describing a process of determining a connecting direction of the plug connector according to an exemplary embodiment.

### DETAILED DESCRIPTION OF THE EXEMPLARY EMBODIMENTS

Hereinafter, one or more exemplary embodiments will be described in detail with reference to the accompanying drawings. A detailed description of well-known functions or components may be omitted in order to avoid obscuring the description with unnecessary detail.

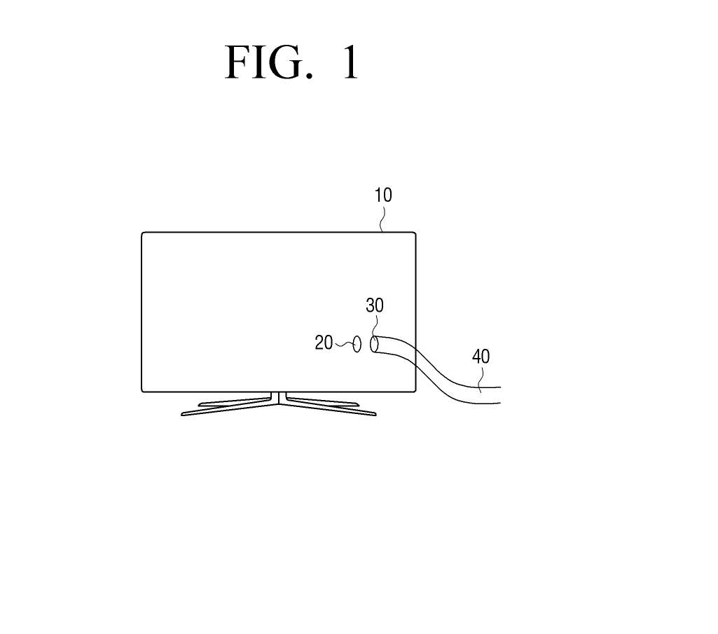

FIG. 1 is a diagram illustrating an electronic apparatus including a receptacle connected to a plug connector according to an exemplary embodiment.

As a non-limiting example of an electronic apparatus, a display device will be described with reference to FIG. 1.

A rear surface of a display device 10 may be provided with a receptacle 20. A plug connector 30 is connectable to the receptacle 20. The plug connector 30 is connected to a cable 40. The display device 10 may transmit and receive data, a control signal, and a power signal to and from an external apparatus through the receptacle 20 and the plug connector 30. The receptacle 20 may be connected to the plug connector 30 regardless of a connecting direction of the plug connector 30 connected to the receptacle 20. A detailed description thereof will be described below.

When the electronic apparatus 100 is a display device, the electronic apparatus 100 may include, as non-limiting examples, a video receiver, a video processor, a tuner, a demodulator, etc.

Although the receptacle 20 is illustrated disposed on a rear surface of the display device 10 is described, this is merely an example, and the receptacle 20 may be disposed at various places on the electronic apparatus.

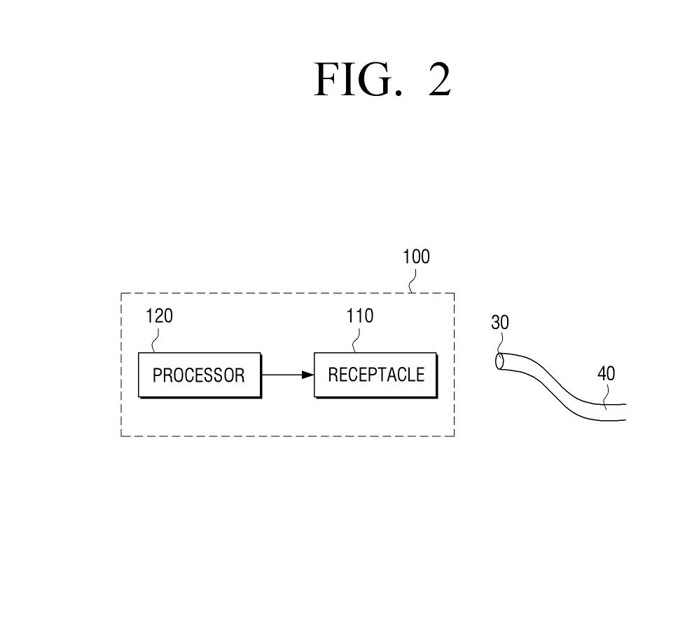

FIG. 2 is a block diagram of the electronic apparatus according to an exemplary embodiment.

As illustrated in FIG. 2, the electronic apparatus 100 includes a receptacle 110 and a processor 120. The electronic apparatus 100 may perform communications with the external apparatus through the receptacle 110, the plug connector 30, and the cable 40. In this case, the electronic apparatus 100 may be implemented as various electronic devices including, as non-limiting examples, a display device, a personal computer (PC), a notebook, a cellular phone, a personal digital assistant (PDA), a monitor, a tablet PC, an electronic book, an electronic picture frame, a smart phone, a personal media player (PMP), an MP3 player, etc.

The receptacle 110 may be disposed on one surface of the electronic apparatus 100. The receptacle 110 may include a plurality of pin groups which may be electrically connected to the plug connector 30. Here, both surfaces of the plug connector 30 may be provided with a plurality of plug terminals. Each of the plurality of pin groups included in the receptacle 110 may be electrically connected to one plug terminal of the plug connector 30. The plug connector 30 may be connected to the receptacle 110 by two connecting methods. One of the two connecting methods may be a method of pointing one surface of the plug connector 30 to the top and the other of the two connecting methods may be a method of pointing the other surface of the plug connector 30 to the top. Although two connection methods are described, this is merely an example, and more connecting directions may be possible. For example, a shape of the plug connector 30 connected to the receptacle 110 may have various surfaces such as, as non-limiting examples, a triangle, a quadrangle, and a pentagon, the plug connector may be connectible in three, four, or five orientations. In this case, the plug connector may have three, four, or five pin groups having rotational symmetry. Further, a shape of the receptacle 110 may correspond to a shape of the plug connector 30.

The processor 120 may detect a voltage value of a first pin of a first pin group which is disposed on one surface or a voltage value of a second pin of a second pin group which is disposed on the other surface, among the plurality of pin groups and may determine the connecting direction of the plug connector 30 based on the detected voltage value of the first pin and the detected voltage value of the second pin.

For example, when the voltage value of the first pin of the first pin group disposed on one surface is small and the voltage value of the second pin of the second pin group disposed on the other surface is maintained, the processor 120 may determine that the plug connector 30 is connected to the receptacle 110 in a first connecting direction and when the voltage value of the first pin of the first pin group disposed on one surface is maintained and the voltage value of the second pin of the second pin group disposed on the other surface is small, the processor 120 may determine that the plug connector 30 is connected to the receptacle 110 in a second connecting direction.

When the plug connector 30 is received in the receptacle 110, the processor 120 may determine the connecting direction of the plug connector 30. In detail, when the plug connector 30 is received in the receptacle 110, if at least one plug terminal disposed on one surface of the plug connector 30 is connected to the pin of the first pin group disposed on one surface of the receptacle 110, the processor 120 may determine that the plug connector 30 is connected to the receptacle 110 in the first direction. Further, when at least one plug terminal disposed on one surface of the plug connector 30 is connected to the pin of the second pin group disposed on the other surface of the receptacle 110, the processor 120 may determine that the plug connector 30 is connected to the receptacle 110 in the second direction. Meanwhile, the processor 120 may be configured as an IC chip, etc., and may control functions of the electronic apparatus besides the above-mentioned functions.

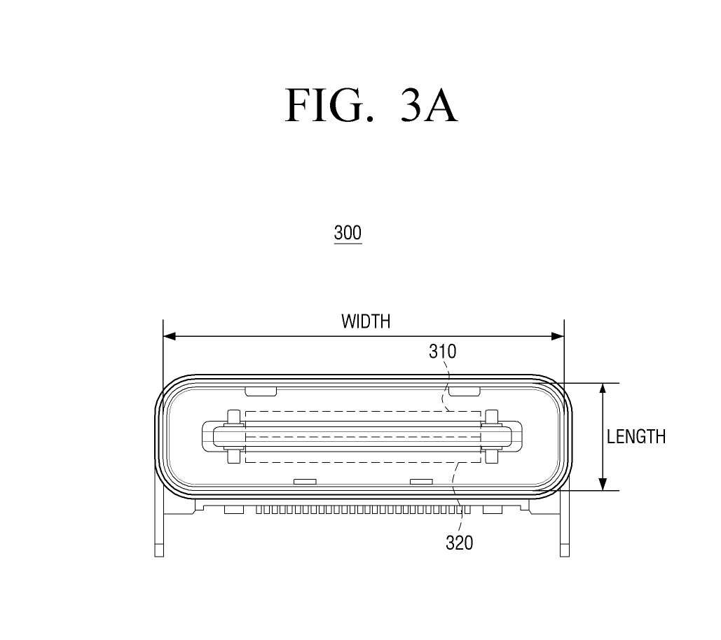

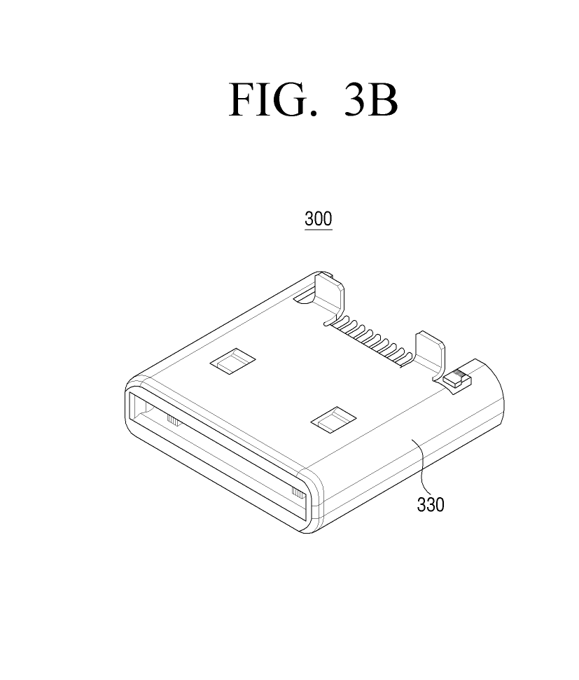

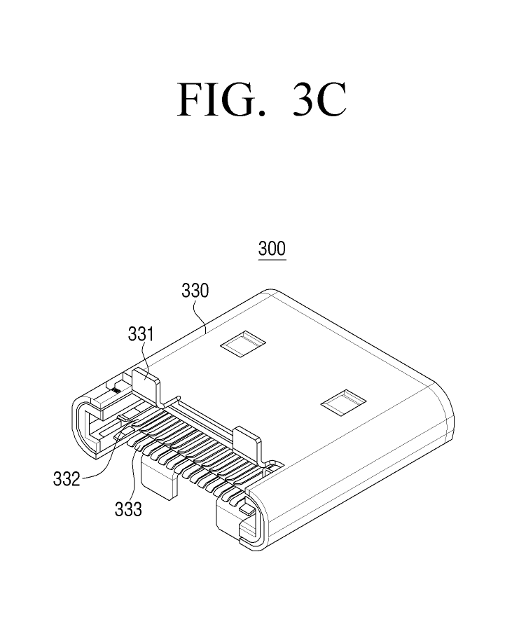

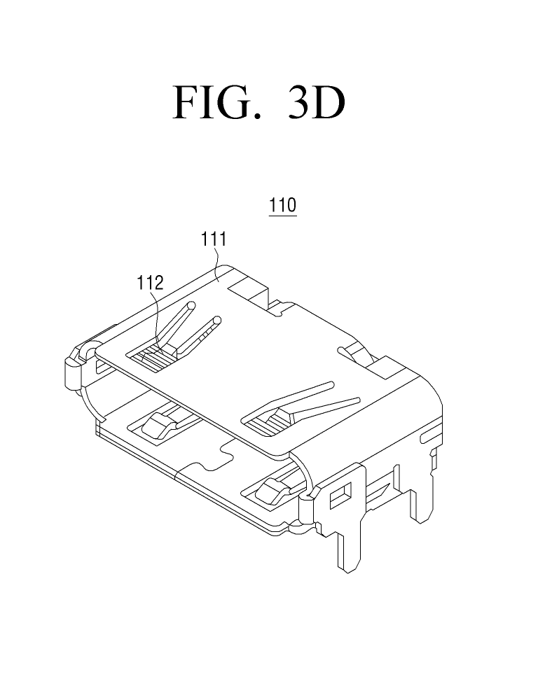

FIG. 3A is a cross-sectional view of the plug connector according to an exemplary embodiment.

Referring to FIG. 3A, a size of the plug connector 300 may be 15.5 mm in width and 4.1 mm in length. A shape of the plug connector 300 is illustrated as a round quadrangle. A size and shape of the plug connector 300 is not limited thereto, and a plug connector 300 may have various sizes and shapes.

In the plug connector 300, a first terminal group may be disposed in a first region 310. A second terminal group may be disposed in a second region 320. The first terminal group disposed in the first region 310 may be connected to one surface of the receptacle 110 and the second terminal group disposed in the second region 320 may be connected to the other surface of the receptacle 110. The user may connect the plug connector 300 to the receptacle 110 without the need to determine the connecting direction when connecting the plug connector 300 to the receptacle 110. The first terminal group and the second terminal group may be switched so that the first terminal group may be disposed in the second region 320 and the second terminal group may also be disposed in the first region 310.

FIGS. 3B to 3D are diagrams illustrating a configuration of the plug connector and the receptacle according to an exemplary embodiment.

Here, FIG. 3B is a perspective view illustrating a rear surface of the plug connector 300 according to an exemplary embodiment and FIG. 3C is a perspective view illustrating a front surface of the plug connector 300.

As illustrated in FIGS. 3B and 3C, the plug connector 300 includes a substrate 332 on which a plurality of pins 333 for transmitting and receiving a signal between devices are formed and a housing 330 in which the substrate 332 is housed.

Referring to FIG. 3C, the substrate 332 serves to firmly holds the plurality pins 333 spaced apart from each other at a predetermined interval. A connecting portion as a portion of the plurality of pins 333 through which a signal is transferred to a pin hole of the receptacle 110 may be formed by any one of gold plating, silver plating, tin plating, and nickel plating.

The housing 330 houses the substrate 332 and the plurality of pins 333 and has a protrusion 331 for firmly fixing the housing 330 of the plug connector 300 to the housing of the receptacle 110 when the plug connector 300 is received in and connected to the receptacle 110. The protrusion 331 pushes up a fixed bar 112 of the housing of the receptacle 110 and the fixed bar 112 returns in place by elasticity. Thus the plug connector 300 may be fixed by confining the protrusion 331 in the fixed bar 112 (see FIG. 3D). However, the housing 330 according to various exemplary embodiments is not limited to a mechanical structure and, therefore, may have various structures in which the receptacle 110 may be fixedly connected to the plug connector 300. Further, according to another exemplary embodiment, the housing 330 may not have a separate structure in which the housing 330 is fixedly connected to the receptacle 110. In this case, the plug connector 300 is connected to the receptacle 110 by using the substrate 332 and the plurality of pins 333 or only the plurality of pins 333.

Referring to FIG. 3D, the receptacle 110 includes a plurality of pin holes for transmitting and receiving a signal between devices and the housing 111 housing the pin holes.

The pin holes are depressed so that the plurality of pins 333 of the plug connector 300 may each be inserted into the pin holes. Further, the plurality of pin holes contacting the plurality of pins 333 may be formed by any one of gold plating, silver plating, tin plating, and nickel plating.

The housing 111 has the plurality of pin holes housed therein and the inside of the housing 111 is depressed to house and connect the plug connector 300. The plug connector 300 is inserted into the depressed space and the plurality of pins 333 are inserted into the pin holes. Further, the housing 111 may include a means for fixedly connecting the housing 111 of the plug connector 300, for example, the fixed bar 112 illustrated in FIG. 3D. The fixed bar 112 is penetratedly formed on a surface of the housing 111 or protrudedly formed inside the housing 111, such that an inlet of the housing 111 narrows to hinder the plug connector 300 from being inserted. When the plug connector 300 is inserted, the fixed bar 112 hinders the protrusion 331 of the housing in the plug connector 300 from proceeding. In this case, when some more force is applied in the insertion direction, the fixed bar 112 moves to adhere to an inner wall of the housing 111 or protrude toward an outside of the housing 111, which forms a space to allow the protrusion 331 of the plug connector 300 to enter the housing 111. However, when the protrusion 331 passes through an end of the fixed bar 112, the fixed bar 112 returns in place by elasticity, and as a result the protrusion 331 is confined in the housing 111. As a result, the plug connector 300 is fixed in the housing 111.

However, the housing 111 according to various exemplary embodiments is not limited to the described mechanical structure and therefore may have various structures in which the receptacle 110 may be fixedly connected to the plug connector 300. For example, according to another exemplary embodiment, the housing 330 may not have a separate structure in which the housing 330 is fixedly connected to the receptacle 110. In this case, the plug connector 300 is connected to the receptacle 110 by using the substrate 332 and the plurality of pins 333 or only the plurality of pins 333.

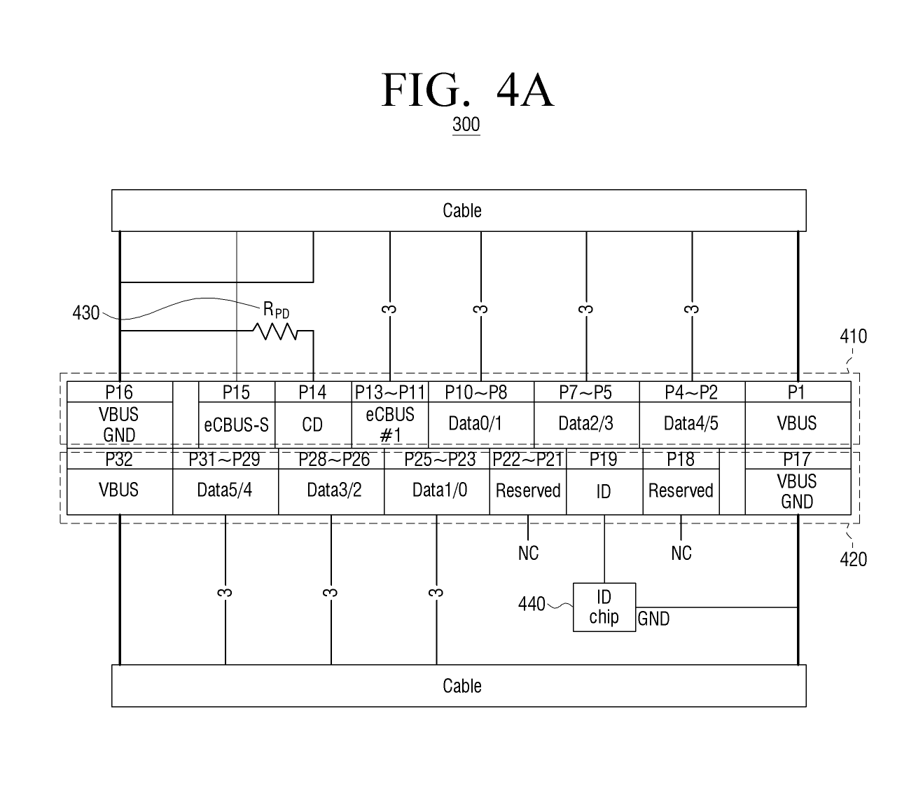

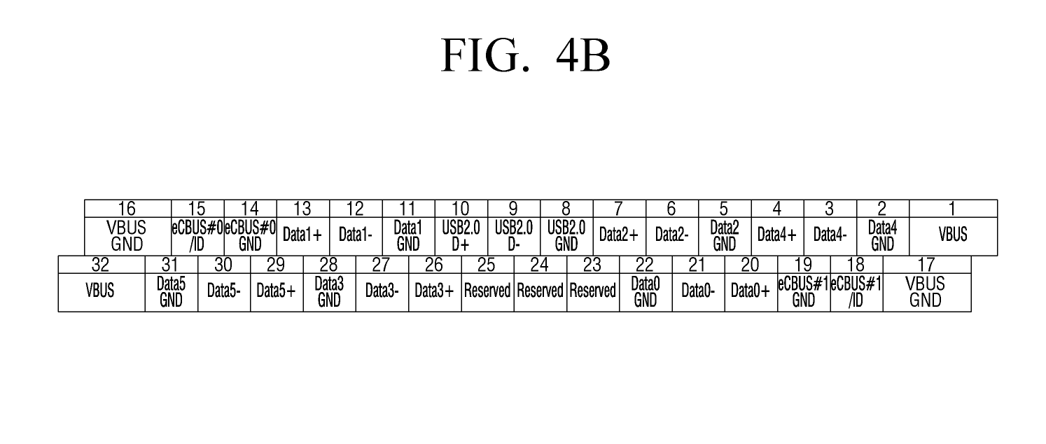

The pin disposition of the first terminal group and the second terminal group in the plug connector 300 will be described in detail with reference to FIG. 4A.

FIG. 4A is a diagram illustrating an internal circuit of the plug connector according to an exemplary embodiment.

Referring to FIG. 4A, the plug connector 300 may include a first terminal group 410, a second terminal group 420, a pull down resistor 430, and a chip 440 for cable identification.

The plug connector 300 may include terminals VBUS P1, P32, P16, and P17 for a power supply, a ground terminal, terminals eCBUS-S P15 and eCBUS P11-P13 for control signal transmission, terminal CD P14 for cable detection, terminals P2 to P4, P5 to P7, P8 to P10, P23 to P25, P26 to P28, and P29 to P31 for data signal transmission, a terminal P19 for cable identification, reserved terminals P21 to P22 and P18, etc.

The terminals VBUS P1, P32, P16, and P17 for a power supply serve to transmit and receive a signal related to a power supply. Further, the terminals P16 and P17 for a power supply may be used as the ground terminal GND together. In particular, the terminal P16 for a power supply and ground may be connected to a ground terminal.

The terminal P17 for a power supply is disposed 180° symmetrical to the P16 and the P1 is also disposed 180° symmetrical to the P32. This is to receive the plug connector 300 in the receptacle 110 regardless of the connecting direction of the plug connector 300 when the plug connector 300 is received in the receptacle 110. Here, the case in which the first terminal group 410 is connected to one surface of the receptacle 110 may be defined as a first connection and the case in which the first terminal group 410 is connected to the other surface of the receptacle 110 may be defined as a second connection.

The terminals eCBUS-S P15 and eCBUS P11-P13 for control signal transmission are terminals for transmitting and receiving a control signal. The abbreviation “eCBUS” is short for an enhanced Control BUS.

The terminal CD <Cable Detection> P14 for cable detection is an important pin to determine whether the electronic apparatus 100 is connected to the plug connector 300. In detail, the terminal CD P14 for cable detection is connected to the pull down resistor and the pull down resistor is connected to the ground terminal. The receptacle 110 of the electronic apparatus 100 is also provided with pins corresponding to the terminal CD P14 for cable detection. When the corresponding pin is called as the first pin, the first pin is connected to a pull up resistor which is connected to a power supply unit. When the plug connector 300 is received in the receptacle 110, the processor 120 of the electronic apparatus 100 may detect the plug connector 300 connected to the electronic apparatus 100 by using the pull up resistor and the pull down resistor for the connection between the terminal CD P14 for cable detection and the first pin. A detailed description thereof will be described below.

The terminals P2 to P4, P5 to P7, P8 to P10, P23 to P25, P26 to P28, and P29 to P31 for data signal transmission may be used as terminals for data transmission between the electronic apparatus 100 and the external apparatus to which the plug connector 300 is connected. In particular, the terminals P2 to P4, P5 to P7, P8 to P10, P23 to P25, P26 to P28, and P29 to P31 may be used for data communication between devices supporting a mobile high-definition link (MHL). Similar to the terminals VBUS P1, P32, P16, and P17 for a power supply, the terminals P2 to P4, P5 to P7, and P8 to P10 for data signal transmission may be disposed 180° symmetrical to the terminals P23 to P25, P26 to P28, and P29 to P31 for data signal transmission.

The terminal ID P19 for cable identification is a terminal for cable identification. The terminal CD P14 for cable detection and the terminal ID P19 for identification may use different terminals P14 and P19. The receptacle 110 uses the pin for cable detection and the pin for identification as the same pin. The terminal ID P19 for cable identification may be connected to the chip 440 for cable identification of the plug connector 300.

The chip 440 for cable identification of the plug connector 300 may store information of the plug connector 300. In detail, the information of the plug connector 300 may include standard information, original product information, cable identification information, etc., of the plug connector 300. When the plug connector 300 is connected to the electronic apparatus 100, the information of the plug connector 300 may be transmitted to the receptacle 110. The electronic apparatus 100 may perform the cable identification using the transmitted information of the plug connector 300. When the cable identification succeeds, a normal signal is transmitted and received to and from the external apparatus through the plug connector 300, but when the cable identification fails, the electronic apparatus 100 may constantly limit the data communication. The identification of the plug connector 300 may also include the identification of the cable connected to the plug connector 300.

Further, when the chip 440 for cable identification receives a signal from the electronic apparatus 100, an ACK signal may be transmitted to the electronic apparatus 100 through the receptacle 110. For example, when the electronic apparatus 100 transmits the identification signal to the terminal P19, the chip 440 for cable identification may transmit a signal corresponding to the identification signal to the electronic apparatus 100. The electronic apparatus may determine whether to authenticate the plug connector 300 using the signal transmitted from the chip 440 for cable identification.

When receiving the identification information of the electronic apparatus 100 from the electronic apparatus 100, the chip 440 for cable identification may also authenticate the electronic apparatus 100.

The pin disposition of the plug connector 300 is not limited to an example illustrated in FIG. 4A and the pin of the plug connector 300 may be disposed in different numbers and arrangements.

FIG. 4B is a diagram illustrating the pin disposition of the plug connector 300 according to another exemplary embodiment.

Referring to FIG. 4B, the plug connector 300 according to an exemplary embodiment has a pin set arranged in two rows. That is, the plug connector 300 includes a first pin set (Nos. 1 to 16 pins) which is disposed in a first row of the plug connector 300 and a second pin set (Nos. 17 to 32 pins) which is disposed in a second row of the plug connector 300.

A VBUS pin, a Data4 ground (GND) pin, a Data4 − pin, a Data4 + pin, a Data2 ground pin, a Data2 − pin, a Data2 + pin, a USB ground pin, a USB D − pin, a USB D + pin, a Data1 ground pin, a Data1 − pin, a Data1 + pin, an eCBUS#0 ground pin, an eCBUS#0/ID pin, and a VBUS ground pin may be disposed in the first pin set of the first row in an order from Nos. 1 to 16.

A VBUS ground pin, an eCBUS#1/ID pin, an eCBUS #1 ground pin, a Data0 + pin, a Data0 − pin, a Data0 ground (GND) pin, three reserved pins, a Data3 + pin, a Data3 − pin, a Data3 ground (GND) pin, a Data5 + pin, a Data5 − pin, a Data5 ground (GND) pin, and a VBUS pin may be disposed in the second pin set of the second row in an order from Nos. 17 to 32.

The VBUS pin is a pin which transmits and receives a power signal to and from the receptacle and the VBUS GND pin is a pin which transmits and receives a ground signal of the VBUS.

The eCBUS/ID pin is a pin which transmits a bi-directional signal and may simultaneously transfer a clock signal and a general data signal. Further, the eCBUS/ID pin may be used to transmit and receive at least one of a control signal, a device identification signal of the plug connector 300, and a connecting direction determination signal.

As such, the plug connector 300 according to an exemplary embodiment does not include separate pins for each of a plurality of functions but performs several functions using one pin, thereby reducing the size of the plug connector 300 and increasing the transmitting and receiving efficiency.

The Data + pin, the Data − pin, and the Data GND pin are a differential pair pin set for transmitting and receiving an audio/video (AV) data signal. The differential pair pin set transmits and receives an AV data in a transition minimized differential signal (TDMS) form. The transition minimized differential signal transmits and receives video, audio, and additional data in a video data period, a data sum period, a control period. Pixel information of a moving picture line is transmitted and received in the video data period and the audio information and the additional information consisting of a series of pieces are transmitted and received in the data sum period. The data sum period is generated in a horizontal blanking interval or a vertical blanking interval. The control period is generated between the video data period and the data sum period.

The Data + pin, the Data − pin, and the Data GND pin may transmit and receive a total of six transition minimized differential signals from Data0 to Data5. Each differential signal pair may have a transmitting and receiving rate of 20 Gbps or more and may transmit and receive a large-capacity video data such as 8K Ultra-high definition (UHD) video data and three-dimensional (3D) video data.

The Data + pin, the Data − pin, and the Data GND pin may generally bi-directionally transmit and receive a signal, but may uni-directionally transmit and receive the AV data at the time of transmitting and receiving the general AV data.

Further, in the plug connector 300 according to an exemplary embodiment, the Data + pin, the Data − pin, and the ground pin set are sequentially arranged. As such, data interference between adjacent pins may be minimized.

The USB ground pin, the USB D − pin, and the USB D + pin are pins for transmitting and receiving data according to an USB standard. As such, the plug connector 300 does not include a separate USB connector and may transmit and receive the USB data and the AV data through a single connector.

Further, as illustrated in FIG. 4B, both ends of the first pin set of the first row and both ends of the second pin set of the second row of the plug connector 300 may be arranged to cross each other. In this case, the ground pin of the second row of the plug connector 300 may be arranged to be positioned between a + signal pin and a − signal pin which are arranged in the first row of the plug connector 300. When the ground pin of the second row is disposed between the Data + pin and the Data − pin of the first row, the ground pin has good signal matching characteristics and thus has robust characteristics against a signal-to-noise ratio. Further, a process of manufacturing a connector may be relatively simple and a wiring may be facilitated when a printed circuit board (PCB) is made. Further, in each pin of the first pin set of the first row and each pin of the second pin set of the second row, the same kinds of pins are disposed 180° symmetrical to each other. For example, the VBUS ground pin is positioned at a position of No. 17 pin of the second row which is symmetrical to the VBUS ground pin which is No. 16 pin of the first row. Further, the VBUS pin is positioned at the position of No. 32 pin of the second row which is symmetrical to the VBUS pin which is No. 1 pin of the first row. Similarly, the eCBUS#1/ID pin and the eCBUS#1 ground pin are positioned at positions of Nos. 18 and 19 pins of the second row which are symmetrical to the eCBUS#0/ID pin and the eCBUS#0 ground pin which are Nos. 15 and 14 pins of the first row. Even in the case of the pin transmitting and receiving the AV data, the Data0 + pin, the Data0 − pin, the Data0 ground pin are positioned at positions of Nos. 20, 21, and 22 pins of the second row which are symmetrical to the Data1 + pin, the Data1 − pin, and the Data1 ground pin which are Nos. 13, 12, and 11 pins of the first row.

However, in the case of the USB pins, as illustrated in FIG. 4B, positions of Nos. 23, 24, and 25 pins of the second row may remain as a reserved. When the Nos. 23, 24, and 25 pins of the second row remain reserved, only a pair of USB signals may be transmitted and received. The USB signal is transmitted and received bi-directionally.

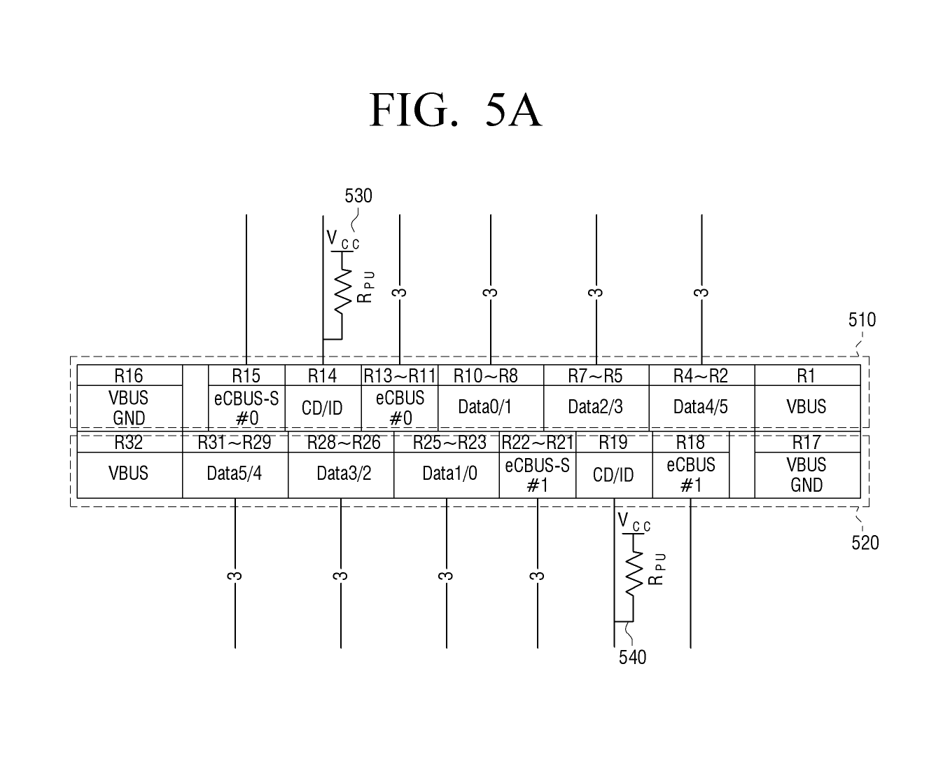

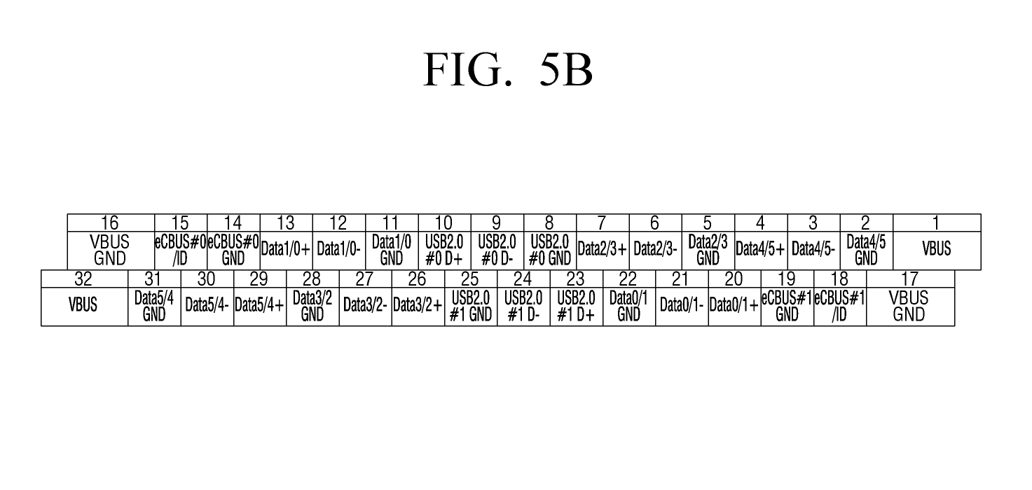

FIG. 5A is a diagram illustrating a circuit configuration of the receptacle of the electronic apparatus according to an exemplary embodiment.

Referring to FIG. 5A, the receptacle 110 of the electronic apparatus 100 includes a first pin hole group 510, a second pin hole group 520, a first pull up resistor 530, and a second pull up resistor 540.

The first pin hole group 510 of the receptacle 110 may be disposed on one surface of the receptacle and the second pin hole group 520 may be disposed on the other surface of the receptacle. The first pin hole group 510 and the second pin hole group 520 of the receptacle 110 may include pin holes VBUS R1, R32, R16, and R17 for a power supply, ground pin holes R16 and R17, pin holes eCBUS-S R15 and eCBUS R11-R13 for control signal transmission, pin holes CD R14 and R19 for cable detection, pin holes R2 to P4, R5 to P7, R8 to P10, R23 to P25, R26 to P28, and R29 to P31 for data signal transmission, and pin holes ID R14 and R19 for cable identification, etc.

The pin holes VBUS R1, R32, R16, and R17 for a power supply serve to transmit and receive a signal related to a power supply. The pin holes R16 and R17 for a power supply may be used as the ground pin hole (GND) together. In particular, the pin holes R16 and R17 for a power supply and ground may be connected to a ground terminal.

The pin hole R17 for a power supply is disposed 180° symmetrical to the R16 and the R1 is also disposed 180° symmetrical to the R32. This is to receive the plug connector 300 in the receptacle 110 regardless of the connecting direction of the plug connector 300 when the plug connector 300 is received in the receptacle 110. Here, the case in which the first terminal group 410 is connected to a first pin hole group of the receptacle 110 may be defined as a first connection and the case in which the first terminal group 410 is connected to a second pin hole group of the receptacle 110 may be defined as a second connection.

The pin holes eCBUS-S R15 and eCBUS R11-R13 for control signal transmission may perform the same role as the terminal for control signal transmission of the plug connector 300 which is described as a usage for transmitting and receiving the control signal.

The pin holes CD <Cable Detection> P14 and R19 for cable detection are an important pin hole to determine whether the receptacle 110 is connected to the plug connector 300. The pin hole CD R14 for first cable detection are connected to the first pull up resistor and the pin hole CD R19 for second cable detection are connected to the second pull up resistor. The first pull up resistor and the second pull up resistor may also be included in the receptacle 110. However, unlike the terminal for cable detection of the plug connector 300, the pin hole for first cable detection and the pin hole for second cable detection may be connected to the power supply. The pin holes CD R14 and R19 for cable detection may also be used as pin holes ID R14 and R19 for cable identification. In particular, the pin hole R19 may be disposed 180° symmetrical to the pin hole R14. Further, the pin holes CD R14 and R19 for cable detection may be compatibly operated as the pin hole receiving the information of the plug connector 300. The information of the plug connector 300 may include at least one of the standard information and the original product information of the plug connector 300.

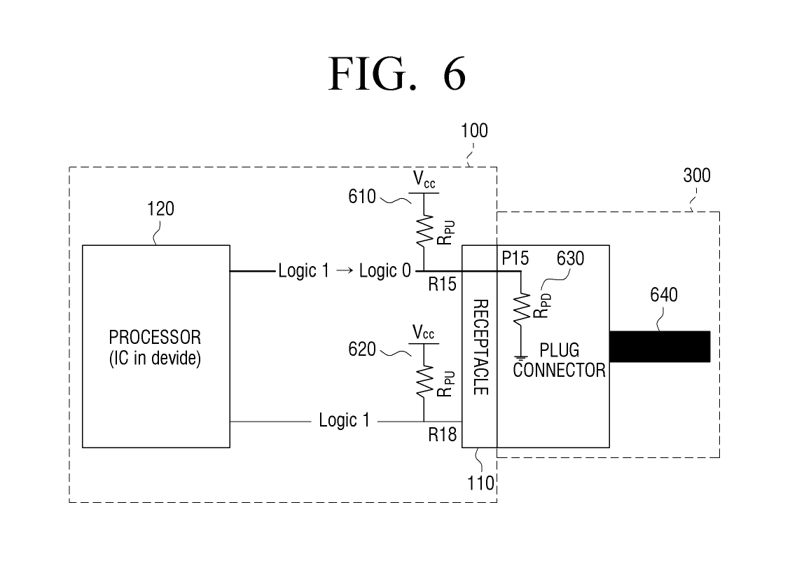

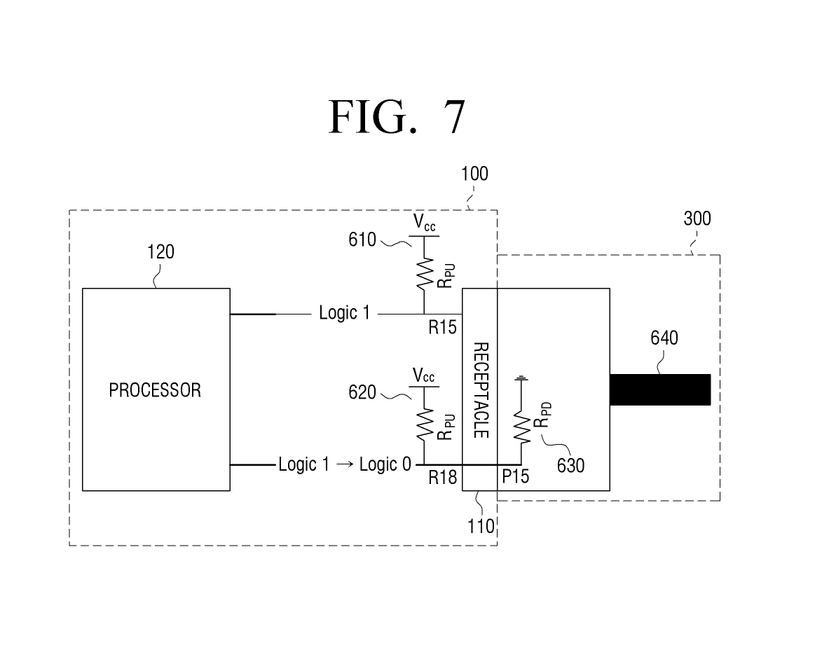

Here, the processor 120 of the electronic apparatus 100 may determine the connecting direction of the plug connector based on whether the terminal CD P14 for cable detection of the plug connector 300 is connected to the pin hole CD R14 of first cable detection or the pin hole CD R19 for second cable detection. That is, it may be determined whether the plug connector 300 is connected to the receptacle 110 in the first connecting direction or the plug connector 300 is connected to the receptacle 110 in the second connecting direction. A detailed description thereof will be described with reference to FIGS. 6 and 7.

Meanwhile, the pin holes R2 to R4, R5 to R7, R8 to R10, R23 to R25, R26 to R28, and R29 to P31 for data signal transmission may be used as for data transmission between the electronic apparatus 100 and the external apparatus to which the plug connector 300 is connected. In particular, data communication between devices supporting the mobile high-definition link (MHL) may be included. Similar to the terminals VBUS R1, R32, R16, and R17 for a power supply, the terminals R2 to R4, R5 to R7, and R8 to R10 for data signal transmission may be disposed 180° symmetrical to the terminals R23 to R25, R26 to R28, and R29 to P31 for data signal transmission.

The pin disposition of the receptacle 110 is not limited to the example illustrated in FIG. 5A and various other pin numbers and configurations may be utilized.

FIG. 5B is a diagram illustrating the pin hole disposition of the receptacle 110 according to another exemplary embodiment.

Referring to FIG. 5B, the receptacle 110 has a pin hole set arranged in two rows. That is, the receptacle 110 includes a first pin hole set (Nos. 1 to 16 pins) which is disposed in a first row of the receptacle 110 and a second pin hole set (Nos. 17 to 32 pins) which is disposed in the second row of the receptacle 110.

A VBUS pin hole, a Data 4/5 ground (GND) pin, a Data 4/50 − pin hole, a Data 4/5 + pin hole, a Data 2/3 ground pin hole, a Data 2/3 − pin hole, a Data 2/3 + pin hole, a USB#0 ground pin hole, a USB#0 D − pin hole, a USB#0 D + pin hole, a Data 1/0 ground pin hole, a Data 1/0 − pin hole, a Data 1/0 + pin hole, an eCBUS#0 ground pin hole, an eCBUS#0/ID pin hole, a VBUS ground pin hole may be disposed in the first pin hole set of the first row in an order from Nos. 1 to 16.

A VBUS ground pin hole, an eCBUS#1/ID pin hole, an eCBUS#1 ground pin hole, a Data0/1 + pin hole, a Data0/1 − pin hole, a Data 0/1 ground (GND) pin hole, a USB#1 D + pin hole, a USB#1 D − pin hole, a USB#1 ground pin hole, a Data3/2 + pin hole, a Data3/2 − pin hole, a Data3/2 ground (GND) pin hole, a Data5/4 + pin hole, a Data5/4 − pin hole, a Data5/4 ground (GND) pin hole, and a VBUS pin hole may be disposed in the second pin set of the second row in an order from Nos. 17 to 32.

The VBUS pin hole is a pin hole which transmits and receives a power signal to and from the connector plug 100 and the VBUS GND pin hole is a pin hole related to a ground signal of the VBUS.

The eCBUS/ID pin hole is a pin hole which transmits a bi-directional signal and may simultaneously receive a clock signal and a general data signal. Further, the eCBUS/ID pin hole may be used to transmit and receive at least one of the control signal, the device identification signal of the plug connector 300, and a connecting direction determination signal.

The plug connector 300 according to an exemplary embodiment does not include the pins for each of a plurality of functions but perform several functions using one pin, thereby reducing a size of the receptacle 110 and increasing the transmitting and receiving efficiency.

The Data + pin hole, the Data − pin hole, and the Data GND pin hole are a differential pair pin hole set for transmitting and receiving the audio/video (AV) data signal. The differential pair pin hole set transmits and receives the AV data in the transition minimized differential signal (TMDS) form. The transition minimized differential signal transmits and receives video, audio, and additional data in the video data period, the data sum period, and the control period. Pixel information of a moving picture line is transmitted and received in the video data period and the audio information and the additional information consisting of a series of pieces are transmitted and received in the data sum period. The data sum period is generated in a horizontal blanking interval or a vertical blanking interval. The control period is generated between the video data period and the data sum period.

The Data + pin hole, the Data − pin hole, and the Data GND pin hole may transmit and receive a total of six transition minimized differential signals from Datat0 to Data5. Each differential signal pair may have a transmitting and receiving rate of 20 Gbps or more and may transmit and receive a large-capacity video data, such as 8K UHD video data and 3D video data.

The Data + pin hole, the Data − pin hole, and the Data GND pin hole may generally bi-directionally transmit and receive a signal, but may uni-directionally transmit and receive the AV data at the time of transmitting and receiving the general AV data.

Further, in the receptacle 110 according to an exemplary embodiment, the Data + pin hole, the Data − pin hole, and the ground pin hole set are sequentially arranged. As such, data interference between adjacent pin holes may be minimized.

The USB ground pin hole, the USB D − pin hole, and the USB D + pin hole are pin holes for transmitting and receiving data according to the USB standard. As such, the receptacle 110 according to an exemplary embodiment does not include a separate USB connector and may transmit and receive the USB data and the AV data through a single connector.

Further, as illustrated in FIG. 5B, both ends of the first pin hole set of the first row and both ends of the second pin hole set of the second row of the receptacle 110 may be arranged to cross each other. In this case, the ground pin hole of the second row of the receptacle 110 may be disposed to be positioned between a + signal pin hole and a − signal pin hole which are arranged in the first row of the receptacle 110. As such, when the ground pin hole of the second row is disposed between the Data + pin hole and the Data − pin hole of the first row, the ground pin hole has good signal matching characteristics and, thus, has robust characteristics against a signal-to-noise ratio. A process of manufacturing a connector may be simplified and a wiring may be facilitated when the connector is mounted in a PCB board.

Further, in each pin hole of the first pin hole set of the first row and each pin hole of the second pin hole set of the second row, the same kind of pin holes are disposed 180° symmetrical to each other. For example, the VBUS ground pin hole is positioned at pin hole No. 17 of the second row which is symmetrical to the VBUS ground pin hole which is No. 16 pin hole of the first row. Further, the VBUS pin hole is positioned at pin hole No. 32 of the second row which is symmetrical to the VBUS pin hole which is No. 1 pin hole of the first row. Similarly, the eCBUS#1/ID pin hole and the eCBUS#1 ground pin hole are positioned at pin holes Nos. 18 and 19 of the second row which are symmetrical to the eCBUS#0/ID pin hole and the eCBUS#0 ground pin hole which are Nos. 15 and 14 pin holes of the first row. Even in the case of the pin hole transmitting and receiving the AV data, the Data0/1 + pin hole, the Data0/1 − pin hole, and the Data0/1 ground pin hole are positioned at pins Nos. 20, 21, and 22 of the second row which are symmetrical to the Data1/0 + pin hole, the Data1/0 − pin hole, and the Data1/0 ground pin hole which are Nos. 13, 12, and 11 pin holes of the first row.

The plug connector 300 may be connected to the receptacle 110 in the form illustrated in FIGS. 4B and 5B but the plug connector 300 may be rotated 180° and connected to the receptacle 110. In this case, the No. 17 pin of the plug connector 300 is connected to the No. 16 pin hole of the receptacle 110, the No. 32 pin of the plug connector 300 is connected to the No. 1 pin hole of the receptacle 110, the No. 1 pin of the plug connector 300 is connected to the No. 32 pin hole of the receptacle 110, and the No. 16 pin of the plug connector 300 is connected to the No. 17 pin hole of the receptacle 110, respectively.

When the receptacle 110 is connected to the plug connector 300, the AV data is received based on the connection direction. When the connection is made in the form illustrated in FIGS. 4B and 5B, the Data1/0 + pin hole, the Data1/0 − pin hole, and the Data1/0 ground pin hole each receive the data of the Data1 + pin, the Data1 − pin, and Data1 ground pin. However, when the plug data 300 is rotated 180° and connected to the receptacle 110, the Data1/0 + pin hole, the Data1/0 − pin hole, and Data1/0 ground pin hole each receive the data of the Data0 + pin, the Data0 − pin, and the Data0 ground pin.

FIGS. 6 and 7 are diagrams illustrating the plug connector and the receptacle connected in the first direction and the second direction according to various exemplary embodiments.

As illustrated in FIG. 6, the plug connector 300 is connected to the electronic apparatus 100. Here, the receptacle 110 includes the first pull up resistor connected to the first pin and the second pull up resistor connected to the second pin, and the processor 120 is configured to detect voltage values of the first pin and the second pin based on the first pull up resistor and the second pull up resistor.

The processor 120 may detect the voltage values of the pin R15 and the pin R18 based on a pull up resistor 610 connected to the pin R15 and a pull up resistor 620 connected to the pin R18.

Further, the processor 120 may determine the connecting direction of the plug connector based on a voltage value of the pin R15 and a voltage value of the pin R18. For example, when the pin R15 is connected to the terminal P15 of the plug connector 300, a logic value is changed from 1 to 0 on the pin R15 by a pull down resistor 630 included in the plug connector 300, and, as a result, the voltage value of the pin R15 is smaller than the preset voltage value. In this case, the processor 120 may determine that the plug connector is connected to the receptacle in the first connecting direction.

Further, the processor 120 may determine that the plug connector 300 is not connected to the electronic apparatus 100 if both of the voltage value of the pin R15 and the voltage value of the pin R18 are larger than the preset voltage value. The preset voltage value is a Vcc value which is connected to the power supply. Here, an example of the Vcc value is 3.3 V.

As in FIG. 6, in FIG. 7 the plug connector 300 is connected to the electronic apparatus 100. However, when the pin R18 is connected to the terminal P15 of the plug connector 300, a logic value is changed from 1 to 0 on the pin R18 by the pull down resistor 630 included in the plug connector 300, and, as a result, the voltage value of the pin R18 is smaller than the preset voltage value. In this case, the processor 120 may determine that the plug connector is connected to the receptacle in the second connecting direction.

When the receptacle 110 is connected to the plug connector 300, the electronic apparatus 100 may determine the connection of the plug connector 300 without a chip for identification of the plug connector 300 or passing through a handshaking process. Accordingly, the electronic apparatus 100 rapidly detects the connection of the plug connector 300, thereby improving the efficiency of the apparatus.

The processor 120 of the electronic apparatus 100 may determine the connecting direction of the plug connector 300 by the above-mentioned method.

When the processor 120 determines the connecting direction of the plug connector 300 based on a pull up resistor connected to receptacle 110 and a pull down resistor included in the plug connector 300, the operation of determining the connecting direction of the plug connector 300 may need to be performed in both the electronic apparatus 100 and the external apparatus.

However, the processor 120 may determine the connecting direction of the plug connector 300 based on a pull down resistor included in the external apparatus connected through the cable 640, not through the plug connector 300.

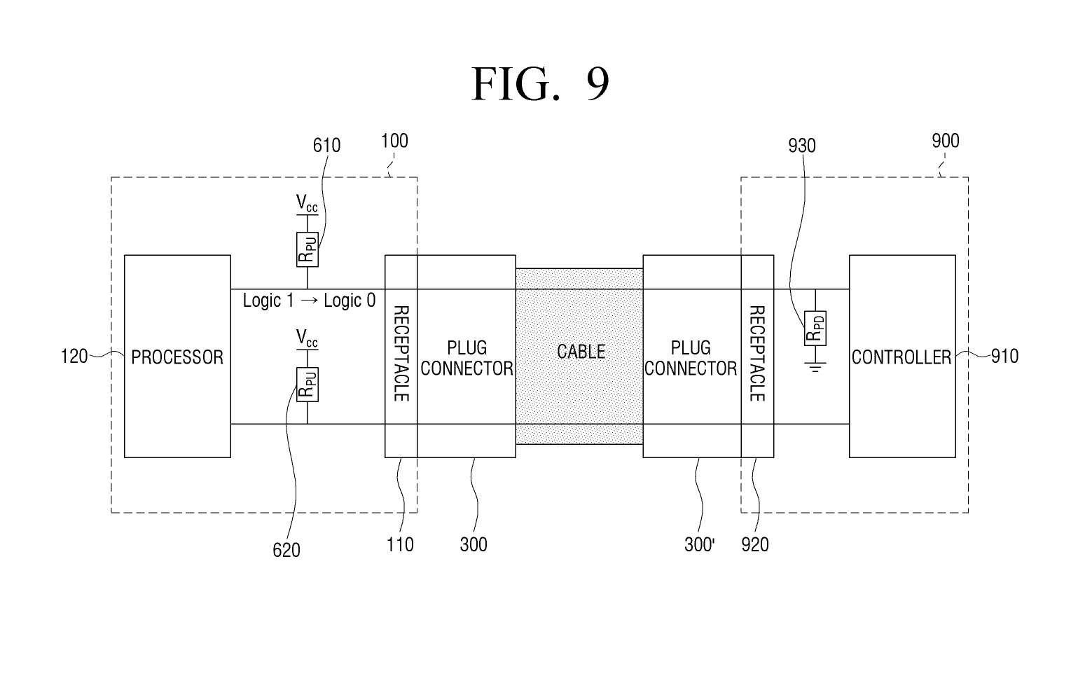

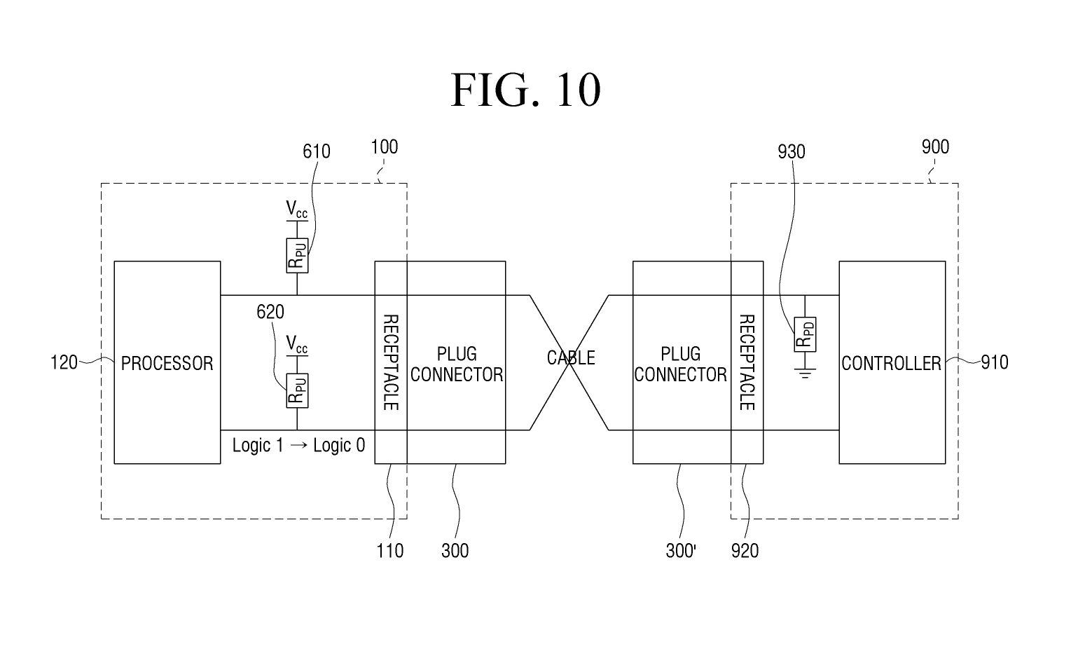

When the processor 120 determines the connecting direction of the plug connector 300 based on the pull down resistor included in the external apparatus which is connected through the cable 640, n the operation of determining the connecting direction of the plug connector 300 may be performed only in the electronic apparatus 100. This will be described in detail with reference to FIGS. 9 and 10.

FIGS. 9 and 10 are diagrams for describing a process of determining a connecting direction of a plug connector according to another exemplary embodiment.

Referring to FIG. 9, the first pin is connected to the first pull up resistor 610, a second pin is connected to the second pull up resistor 620, and the processor 120 may detect the voltage value of the first pin and the voltage value of the second pin based on a pull down resistor 930 included in an external apparatus 900 connected through the plug connector 300 when the plug connector 300 is received in the receptacle 110.

FIG. 9 illustrates the case in which the cable is not twisted and the plug connector 300 and a plug connector 300′ are each connected to the electronic apparatus 100 and the external apparatus 900 in the same direction. The non-twisted state of the cable 640 means that the plug connectors 300 and 300′ are both connected to the electronic apparatus 100 and the external apparatus 900 in the first direction or are both connected to the electronic apparatus 100 and the external apparatus 900 in the second direction.

Here, the same direction includes both of the case in which the plug connector 300 is connected to the electronic apparatus 100 in the first direction and the plug connector 300′ is connected to the external apparatus 900 in a first direction and the case in which the plug connector 300 is connected to the electronic apparatus 100 in the second direction and the plug connector 300′ is connected to the external apparatus 900 in a second direction.

Since the pull down resistor exists in the external apparatus 900 connected through the cable 640 and not in the plug connector 300, the case in which the plug connector 300 is connected to the electronic apparatus 100 in the first direction and the plug connector 300′ is connected to the external apparatus 900 in the first direction and the case in which the plug connector 300 is connected to the electronic apparatus 100 in the second direction and the plug connector 300′ is connected to the external apparatus 900 in the second direction are not different but may be considered the same.

Therefore, in the case in which the plug connector 300 is connected to the electronic apparatus 100 in the first direction and the plug connector 300′ is connected to the external apparatus 900 in the first direction and the case in which the plug connector 300 is connected to the electronic apparatus 100 in the second direction and the plug connector 300′ is connected to the external apparatus 900 in the second direction, the pull down resistor 930 existing in the external apparatus 900 affects only the voltage value of the first pin to which the pull up resistor 610 is connected and the processor 120 may detect that the plug connector 300 is connected to the receptacle 110 in the second connecting direction if the voltage value of the first pin is changed from logic 1 to logic 0 by the pull down resistor 930 of the external apparatus 900 and, thus, is smaller than the preset voltage value and the voltage value of the second pin is larger than the preset voltage value.

FIG. 10 illustrates the case in which the plug connector 300 and the plug connector 300′ are connected to the electronic apparatus 100 and the external apparatus 900 in different directions in the state in which the cable is twisted. The twisted state of the cable 640 means that the plug connector 300 is connected to the electronic apparatus 100 in the first direction and the plug connector 300′ is connected to the external apparatus 900 in the second direction or the plug connector 300 is connected to the electronic apparatus 100 in the second direction and the plug connector 300′ is connected to the external apparatus 900 in the first direction.

Here, the different directions include both of the case in which the plug connector 300 is connected to the electronic apparatus 100 in the first direction and the plug connector 300′ is connected to the external apparatus 900 in the second direction and the case in which the plug connector 300 is connected to the electronic apparatus 100 in the second direction and the plug connector 300′ is connected to the external apparatus 900 in the first direction.

Since the pull down resistor exists in the external apparatus 900 connected through the cable 640 and not through the plug connector 300, the case in which the plug connector 300 is connected to the electronic apparatus 100 in the first direction and the plug connector 300′ is connected to the external apparatus 900 in the second direction and the case in which the plug connector 300 is connected to the electronic apparatus 100 in the second direction and the plug connector 300′ is connected to the external apparatus 900 in the first direction are different may be considered as the same.

In the twisted state, the pull down resistor 930 existing in the external apparatus 900 affects only the voltage value of the second pin connected to the pull up resistor 620 and the processor 120 may detect that the plug connector 300 is connected to the receptacle 110 in the first connecting direction if the voltage value of the second pin is changed from logic 1 to logic 0 by the pull down resistor 930 of the external apparatus 900 and, thus, is smaller than the preset voltage value and the voltage value of the first pin is larger than the preset voltage value. In other words, the first connecting direction may mean the connecting direction of the plug connector 300 in the state in which the cable 640 is twisted.

If the pull down resistor is not included in the plug connector 300 connected to the electronic apparatus 100 but is included in the external apparatus 900 connected to the electronic apparatus 100, each of the electronic apparatus 100 and the external apparatus 900 need not determine the connecting direction of each plug connector 300 and 300′, but only the electronic apparatus 100 may need to determine the twisting of the cable to determine the connecting direction of the plug connectors 300 and 300′.

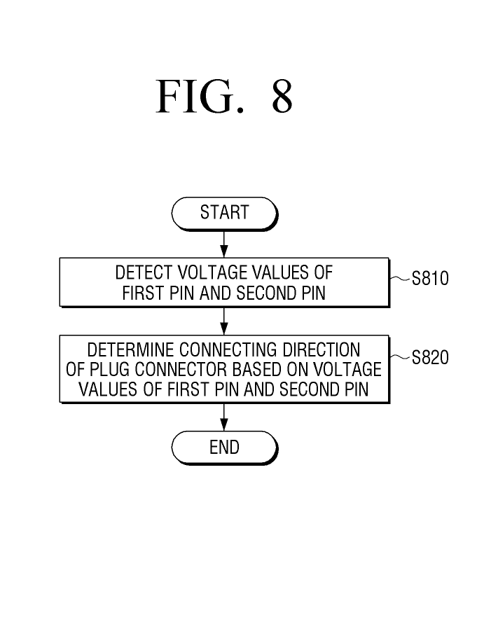

FIG. 8 is a flowchart illustrating a method of connecting the plug connector and the receptacle according to an exemplary embodiment.

Referring to FIG. 8, first, the voltage values of the first pin of the first pin group disposed on one surface and the second pin of the second pin group disposed on the other surface, among the plurality of pin groups are sensed (S810). Here, the first pin and the second pin may be pins for cable detection. Further, the first pin and the second pin may be connected to pull up resistors. When the plug connector is connected to the electronic apparatus, if the first pin or the second pin is connected to one terminal of the plug connector, in particular, the terminal for cable detection, the electronic apparatus may detect the connecting direction of the plug connector. Therefore, the user may use the electronic apparatus and the plug connector regardless of the connecting direction of the plug connector.

Next, the electronic apparatus determines the connecting direction of the plug connector based on the detected voltage value of the first pin and the detected voltage value of the second pin (S820). Here, the first pin and the second pin may be the pin for cable detection.

The method for determining, by the electronic apparatus, the connecting direction of the plug connector may include detecting that the plug connector is connected to the receptacle in the first connecting direction if the voltage value of the first pin of the electronic apparatus is larger than the preset voltage value and the voltage value of the second pin is smaller than the preset voltage value. The first pin and the second pin may be used as the usage of the pin for cable detection. Further, if the voltage value of the first pin is smaller than the preset voltage value and the voltage value of the second pin is larger than the preset voltage value, the electronic apparatus may determine that the plug connector is connected to the receptacle in the second connecting direction opposite to the first connecting direction.

Further, the state in which the electronic apparatus is unplugged from the plug connector may also be represented.

In this case, if the voltage value of the first pin and the voltage value of the second pin are both larger than the preset voltage value, and it may be determined that the plug connector is not connected to the electronic apparatus. The detailed description thereof is already described and therefore will be omitted.

As described above, the detecting the voltage value of the first pin of the first pin group disposed on one surface or the voltage value of the second pin of the second pin group disposed on the other surface among the plurality of pin groups according to an exemplary embodiment and the determining the connecting direction of the plug connector based on the detected voltage value of the first pin and the detected voltage value of the second pin may be implemented by a program including an algorithm executable by a computer, in which the program may be provided stored in a non-transitory computer readable medium.

The non-transitory computer readable medium is not a medium that stores data for a short while, such as a register, a cache, a memory, or the like, but is a medium that semi-permanently stores data therein and is readable by a device. For example, various applications or programs described above may be stored and provided in the non-transitory computer readable medium such as a compact disk (CD), a digital versatile disk (DVD), a hard disk, a Blu-ray disk, a universal serial bus (USB) memory stick, a memory card, a read only memory (ROM), or the like.

As described above, according to one or more exemplary embodiments, it is possible to connect the plug connector to the receptacle of the electronic apparatus without the user paying special attention. Thereby, the user convenience may be improved.

Further, when the electronic apparatus is connected to the plug connector including the cable, the plug connector connected to the electronic apparatus may be detected without performing handshaking with a chip for identification included in the plug connector, thereby improving the efficiency of the apparatus.

Although certain exemplary embodiments have been disclosed for illustrative purposes, those skilled in the art will appreciate that various modifications, additions, and substitutions are possible, without departing from the spirit, principles, and gist of the present invention as disclosed in the accompanying claims and their equivalents. Accordingly, such modifications, additions, and substitutions should be understood to fall within the technical idea of the present invention.

What is claimed is:

1. An electronic apparatus, comprising:
a receptacle comprising:
a plurality of pin groups electrically connectable to the plug connector comprising a plurality of plug terminals disposed on respective surfaces of the plug connector;
a first pin group of the plurality of pin groups disposed on a first surface comprising a first pin; and
a second pin group of the plurality of pin groups disposed on a second surface comprising a second pin; and
a processor configured to detect a voltage value of the first pin, to detect a voltage value of the second pin, and to determine a connecting direction of the plug connector based on the detected voltage value of the first pin and the detected voltage value of the second pin.

2. The electronic apparatus as claimed in claim 1, wherein the processor is further configured to determine the connecting direction of the plug connector based on whether at least one plug terminal disposed on a first surface of the plug connector is connected to the first pin group or the second pin group, when the plug connector is received in the receptacle.

3. The electronic apparatus as claimed in claim 2, wherein the first pin of the first pin group and the second pin of the second pin group are 180° symmetrical to each other, and
the processor is further configured to determine the connecting direction of the plug connector based on whether the at least one plug terminal disposed on the first surface of the plug connector is connected to the first pin or the second pin.

4. The electronic apparatus as claimed in claim 3, wherein
the receptacle further comprises:
a first pull up resistor connected to the first pin;
and a second pull up resistor connected to the second pin, and
the processor is further configured to detect the voltage values of the first pin and the second pin based on the first pull up resistor and the second pull up resistor.

5. The electronic apparatus as claimed in claim 4, wherein the at least one plug terminal disposed on the first surface of the plug connector is connected to a ground terminal.

6. The electronic apparatus as claimed in claim 1, wherein the first pin and the second pin of the receptacle are configured to be used for at least one of cable detection and cable identification.

7. The electronic apparatus as claimed in claim 1, wherein the receptacle is a receptacle for a mobile high-definition link (MHL).

8. The electronic apparatus as claimed in claim 1, wherein
the first pin group comprises a first pair of end pins configured to supply power,
the second pin group comprises a second pair of end pins configured to supply power, and
each of the first pin group and the second pin group comprise at least one of a pin for data signal transmission, a pin for control signal transmission, a ground pin, and a pin for cable detection.

9. The electronic apparatus as claimed in claim 8, wherein the pin for cable detection is configured to be operated as a pin for receiving information of the plug connector.

10. The electronic apparatus as claimed in claim 1, wherein
the receptacle comprises:
a first pull up resistor connected to the first pin;
and a second pull up resistor connected to the second pin, and
the processor is further configured to detect the voltage value of the first pin and the voltage value of the second pin based on a pull down resistor included in an external apparatus connected through the plug connector, when the plug connector is received in the receptacle.

11. The electronic apparatus as claimed in claim 10, wherein the processor is further configured to:
determine, in response to the voltage value of the first pin being detected to be larger than a preset voltage value and the voltage value of the second pin being detected to be smaller than the preset voltage value, that the plug connector is connected to the receptacle in a first connecting direction, and
determine, in response to the voltage value of the first pin being detected to be smaller than the preset voltage value and the voltage value of the second pin being detected to be larger than the preset voltage value, that the plug connector is connected to the receptacle in a second connecting direction.

12. A receptacle configured to be connected to a plug connector, comprising:
a first pin group disposed on a first surface; and
a second pin group disposed on a second surface,
wherein the first pin group comprises a first pin connected to a first pull up resistor,
wherein the second pin group comprises a second pin connected to a second pull up resistor, and
wherein the second pin is disposed 180° symmetrical to the first pin.

13. The receptacle as claimed in claim 12, wherein the first pin and the second pin of the receptacle are configured to be used for at least one of cable detection and cable identification.

14. A plug connector configured to be connected to a receptacle, comprising:
a first terminal group disposed on a first surface; and
a second terminal group disposed on a second surface,
wherein the first terminal group comprises a first terminal connected to a ground terminal.

15. The plug connector as claimed in claim 14, wherein the first terminal is connected to the ground terminal through a pull down resistor.

16. The plug connector as claimed in claim 14, further comprising a chip for identification of the plug connector,
wherein the second terminal group comprises a second terminal disposed 180° symmetrical to the first terminal and connected to the chip.

17. The plug connector as claimed in claim 16, wherein
the chip comprises information of the plug connector, and
the information of the plug connector comprises at least one of standard information and original product information of the plug connector.

18. A connecting method of an electronic apparatus comprising a plurality of pin groups electrically connected to a plug connector, the connecting method comprising:
detecting a voltage value of a first pin of a first pin group of the plurality of pin groups disposed on a first surface;
detecting a voltage value of a second pin of a second pin group of the plurality of pin groups disposed on a second surface; and
determining a connecting direction of the plug connector based on the detected voltage values of the first pin and the second pin.

19. The connecting method as claimed in claim 18, wherein the determining comprises:
determining, in response to the voltage value of the first pin being detected to be larger than a preset voltage value and the voltage value of the second pin being detected to be smaller than the preset voltage value, that the plug connector is connected to a receptacle in a first connecting direction; and
determining, in response to the voltage value of the first pin being detected to be smaller than the preset voltage value and the voltage value of the second pin being detected to be larger than the preset voltage value, that the plug connector is connected to the receptacle in a second connecting direction opposite to the first connecting direction.

20. The connecting method as claimed in claim 19, wherein the determining further comprises determining, in response to both of the voltage value of the first pin and the voltage value of the second pin being detected to be larger than the preset voltage value, that the plug connector is not connected to the electronic apparatus.
